(19) United States
(12) Patent Application Publication
(10) Pub. No.: US 2025/0074232 A1
(43) Pub. Date: Mar. 6, 2025

(54) CHARGING STATIONS, CHARGING PODS, CHARGING FACILITIES, AND RELATED METHODS

(71) Applicant: One Power Company, Findlay, OH (US)

(72) Inventors: Jereme Kent, Findlay, OH (US); Darshan Bhosale, Findlay, OH (US); Sophia Li, Albuquerque, NM (US)

(73) Assignee: One Power Company, Findlay, OH (US)

(21) Appl. No.: 18/825,416

(22) Filed: Sep. 5, 2024

Related U.S. Application Data
(60) Provisional application No. 63/536,598, filed on Sep. 5, 2023.

(51) Int. Cl. B60L 53/31; B60L 53/16; B60L 53/18; B60L 53/35; B60L 53/66

(52) U.S. Cl. CPC B60L 53/31; B60L 53/16; B60L 53/18; B60L 53/35; B60L 53/66

(57) ABSTRACT

Charging stations, charging pods, charging facilities, methods of charging an electric vehicle, methods of charging multiple electric vehicles, and methods of operating a charging facility are described. A charging pod includes a base on which multiple electric vehicles can be positioned; a battery charger; a support beam extending from the base and having an axis; first and second support members, first and second booms, and first and second charging cables. A barrier extends around the first support member and is disposed above the base.

### FIELD

The disclosure relates generally to the field of electric vehicles. More particularly, the disclosure relates to charging stations, charging pods, and charging facilities for charging batteries of electric vehicles. The disclosure also relates to methods of charging a battery of an electric vehicle, methods of charging batteries of multiple electric vehicles, and methods of operating an electric vehicle battery charging facility. Specific examples described herein relate to apparatuses and methods useful for charging batteries of electric vehicles, such as electric semi-trucks and other electric vehicles.

### BACKGROUND

Electric vehicles represent a growing segment of total vehicles on roads in many areas of the world. While this growth is currently centered on automobiles and passenger trucks, electric vehicle adoption rates are increasing in other categories, too, including delivery vans, utility trucks, and semi-trucks. As adoption of electric vehicles continues, new apparatuses, facilities, and methods will be needed to accommodate the growing and changing needs for charging electric vehicles. Currently available charging stations and charging facilities are not well-equipped to handle the growing array of types of electric vehicles, including electric semi-trucks with tractor unites and trailers.

A need exists, therefore, for improved apparatuses and methods useful for charging batteries of electric vehicles, including charging stations, charging pods, and charging facilities for electric vehicles, methods of charging a battery of an electric vehicle, methods of charging batteries of multiple electric vehicles, and methods of operating an electric vehicle battery charging facility.

### BRIEF SUMMARY OF SELECTED EXAMPLES

Various example charging stations for electric vehicles are described.

An example charging station for electric vehicles comprises a battery charger; a support member disposed over a support beam having an axis; a boom attached to and extending radially outward from the support member; and a charging cable operatively connected to the battery charger and including a connector adapted to be electrically connected to an electric vehicle to charge the battery of the electric vehicle via battery charger. The boom is configured to be rotated about the axis of the support beam.

Various example charging pods for electric vehicles are described.

An example charging pod for electric vehicles comprises a base on which multiple electric vehicles can be positioned; a battery charger; a support beam extending from the base and having an axis; a support member disposed over the support beam; a boom attached to and extending radially outward from the axis; and a charging cable operatively connected to the battery charger and including a connector adapted to be electrically connected to an electric vehicle to charge the battery of the electric vehicle via battery charger. The boom is configured to be rotated about the axis of the support beam.

Another example charging pod for electric vehicles comprises a base on which multiple electric vehicles can be positioned; a battery charger; a support beam extending from the base and having an axis; a first support member disposed over the support beam; a second support member disposed over the support beam and axially spaced from the first support member along the axis; a first boom attached to and extending radially outward from the first support member, the first boom configured to be rotated about the axis; a second boom attached to and extending radially outward from the second support member, the second boom configured to be rotated about the axis; a first charging cable attached to the first boom and operatively connected to the battery charger, the first charging cable including a first connector adapted to be electrically connected to an electric vehicle to charge the battery of the electric vehicle via battery charger; a second charging cable attached to the second boom and operatively connected to the battery charger, the second charging cable including a second connector adapted to be electrically connected to an electric vehicle to charge the battery of the electric vehicle via battery charger; and a barrier extending around the first support member and disposed above the base.

Various example charging facilities for electric vehicles are described.

An example charging facility for electric vehicles comprises a plurality of charging pods according to an embodiment positioned on a surface, such as a portion of the earth.

Various example methods of charging a battery of an electric vehicle, methods of charging batteries of multiple electric vehicles are described, and methods of operating an electric vehicle battery charging facility are described.

Additional understanding of the inventive charging stations, charging pods, charging facilities, methods of charging a battery of an electric vehicle, methods of charging batteries of multiple electric vehicles, and methods of operating an electric vehicle battery charging facility can be obtained by reviewing the detailed description of selected examples, below, and the referenced drawings.

### DESCRIPTION OF FIGURES

FIG. 1 is a perspective view of an example charging station.

FIG. 2 is a perspective view, partially broken away, of the support member and boom of the charging station illustrated in FIG. 1.

FIG. 3 is a perspective view of an example charging pod.

FIG. 4 is a perspective view of an example charging facility.

FIG. 5 is a perspective view of another example charging station.

FIG. 6 is a flowchart illustration of an example method of charging a battery of an electric vehicle.

FIG. 7 is a flowchart illustration of an example method of charging batteries of multiple electric vehicles.

FIG. 8 is a flowchart illustration of an example method of operating an electric vehicle battery charging facility.

### DETAILED DESCRIPTION OF SELECTED EXAMPLES

The following detailed description and the appended drawings describe and illustrate various example charging stations, charging pods, and charging facilities for electric vehicles, and methods of charging a battery of an electric vehicle, methods of charging batteries of multiple electric vehicles, and methods of operating an electric vehicle battery charging facility. The description and illustration of these examples enable one skilled in the art to make and use examples of the inventive charging stations, charging pods, and charging facilities for electric vehicles, and to perform examples of the inventive methods of charging a battery of an electric vehicle, methods of charging batteries of multiple electric vehicles, and methods of operating an electric vehicle battery charging facility. The inclusion of detailed descriptions and illustrations of these selected examples is not intended to limit the scope of the invention, or its protection, in any manner. Furthermore, the invention is capable of being practiced or performed in various ways and the examples described and illustrated herein are not considered exhaustive.

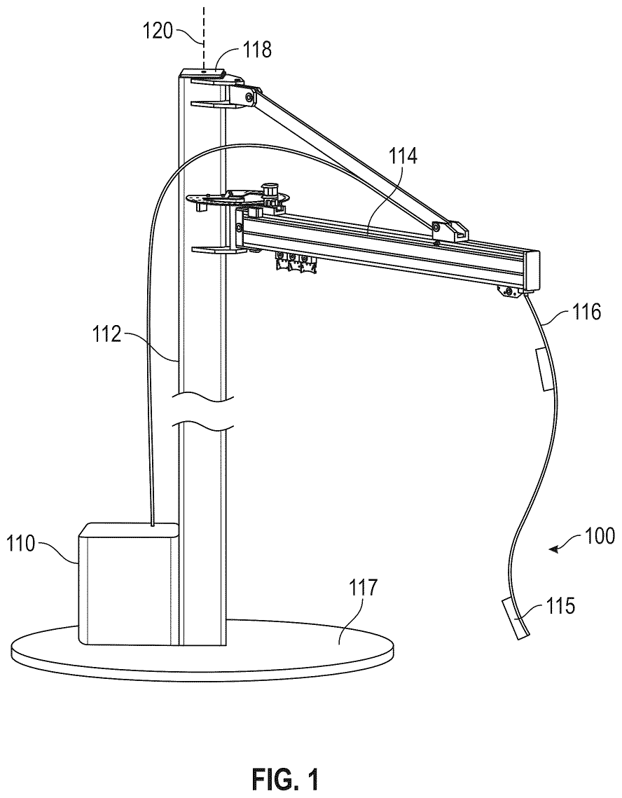

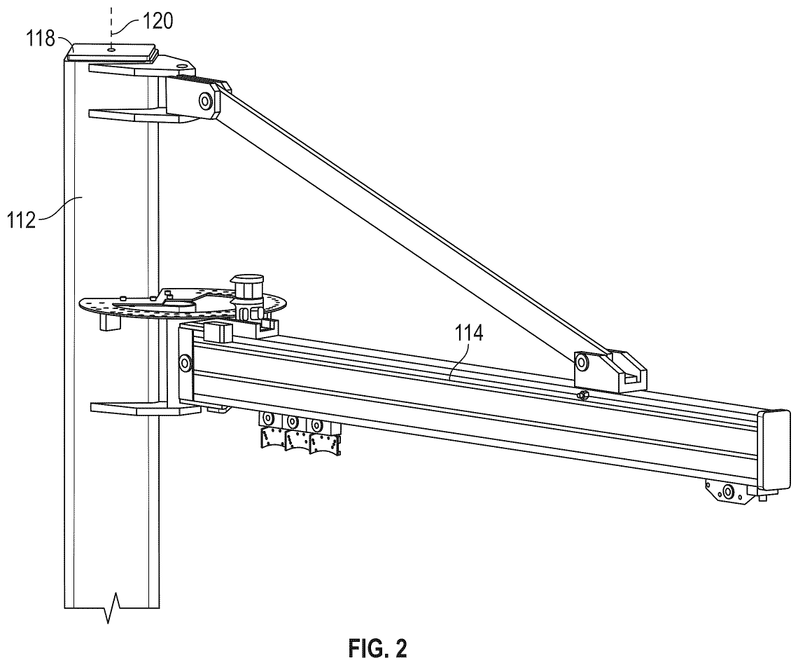

Each of FIGS. 1 and 2 illustrates an example charging station 100 or a component of the example charging station 100. The charging station 100 includes a battery charger 110, a support member 112, a boom 114 attached to and extending radially outward from the support member 112, and a charging cable 116 that is operatively connected to the battery charger and that includes a connector 115 adapted to be electrically connected to an electric vehicle to charge the battery of the electric vehicle via battery charger 110. Support member 112 extends from base 117, which can be a section of ground, support material disposed on the ground, such as concrete, or another suitable material.

FIG. 2 illustrates a perspective view of a portion of the support member 112 and the boom 114 of the charging station 100. In the illustrated embodiment, the support member 112 is disposed over a support beam 118. One or both of the support member 112 and the boom 114 is configured to rotate about an axis 120 of the support beam 118. In this example, one boom 114 is secured to the support member 112. However, in some embodiments, multiple booms, each with an associated charging cable, can be attached to a support member. In these examples, multiple independently rotatably support members can be disposed over or otherwise associated with a common support beam, axially spaced or adjacent each other along the support beam. In the example illustrated in FIGS. 1 and 2, the support member 112 is configured to rotate 360 degrees about the axis 120 and support beam 118. In some examples, however, the support member may be configured to rotate about the axis less than 360 degrees, such as 270 degrees, about 270 degrees, less than 270 degrees, 180 degrees, about 180 degrees, less than 180 degrees, 90 degrees, about 90 degrees, less than 90 degrees, 45 degrees, about 45 degrees, less than 45 degrees, 30 degrees, about 30 degrees, less than 30 degrees, 15 degrees, about 15 degrees, and less than 15 degrees. This rotation enables a user of the charging station to position the boom 114, and its associated charging cable 116, in a suitable position for charging a battery, such as a battery in an electric vehicle adjacent the charging station 100. Also, in addition rotating about the axis 120, one or both of the support member 112 and boom 114 can be configured to rotate or move vertically during rotation about the axis 112. Including a support member 112, boom 114, or both configured in this manner is considered advantageous at least because it allows for increasing a clearance between the support member, boom, and even an attached charging cable and a battery or object including a battery being charged at the charging station, such as an electric vehicle, during, before, or after a charging session. In some embodiments, this vertical movement is accomplished during rotation about the axis 112; in other embodiments, rotation about the axis 112 can only occur after the vertical movement is accomplished to ensure the support member 112, boom 114, and/or charging cable is sufficiently clear of objects near the charging station, such as a battery or object containing a battery, such as an electric vehicle.

The support member can be positioned manually, such as by applying a pushing or pulling force on the support member 112, boom 114, or both to rotate the support member about axis 120. In some embodiments, the support member 112 is controllable by a support member interface. In some embodiments, the support member interface may be local to the charging station 100, allowing on-site operators to rotate the support member 112. In some configurations, the support member interface may be remote, enabling control of rotation of the support member 112 by a remote device, such as a remote control, mobile computing device, such as a smartphone, or other suitable controller. The support member 112 may be configured to actuate based on an algorithm. The support member 112 can be configured to have movement in addition to, or as an alternative to, rotational movement. For example, the support member 112 may be configured to move along the axis 120 of the support beam 118. In one example charging station, the support member 112 can be moved vertically along the axis 120 and rotatably about the axis 120, allowing a user of the charging station to position the boom 114 in a suitable position based on a height and radial location of a battery interface, such as a battery charging connector within an electric vehicle positioned adjacent the charging station.

The boom 114 is directly connected to the support member 112. The boom 114 may be integral with the support member 112 or may comprise a separate member 112 or members attached to the support member 112. The boom 114 is configured to translate a charging cable 116 about the axis 120. The charging cable 116 is configured to facilitate electrical communication between the vehicle charger 110 and a vehicle in a suitable location adjacent the charging station 100. The boom 114 is configured to move about the axis 120 along with the support member 112 to facilitate suitable positioning of the charging cable 116 when during use of the charging station 100, such as during charging of a vehicle positioned adjacent the charging station 100. The support member 112 may determine the lateral or horizontal movement, while the boom 114 may actuate the charging cable 116 in vertical dimensions. The boom 114 may be capable to move the interface end of the charging cable 116 to a vehicle. The interface end may be designed for a direct connection with a battery charging interface, such as a battery charging interface of an electric vehicle. The boom 114 may be configured to accommodate vehicles of various heights. The boom 114 may be configured to raise and lower the charging cable 116. Such vertical movement allows for the positioning of the interface end of the charging cable 116 to facilitate connection to a charging interface of a battery, such as a charging port of an electric vehicle. To achieve this raising and lowering functionality, the boom 114 may include a raising and lowering mechanism to moves the charging cable 116, or a portion of the charging cable, vertically.

The boom 114 may also be configured with sensors 330 to detect the proximity of a charging interface, such as a charging port of an electric vehicle. Any suitable sensors can be included, such as proximity sensors, motion sensors, light sensors, acoustic sensors, and the like.

The boom 114 may also have a flexible joint or pivot point, allowing for slight angular adjustments. For example, the boom 114 may be configured to pivot about an axis perpendicular to the support member 112. This feature may provide added flexibility in positioning the charging cable 116.

The boom 114 may also have a locking mechanism. Once a desired position is reached, the boom 114 may be locked in place to facilitate a rugged connection between the charging cable 116 and a charging interface, such as a battery port of an electric vehicle, for example.

In some embodiments, the boom 114 may include a crane head. The crane head is configured to translate about the body of the boom 114. The crane head may use a worm gear or other suitable structure to translate about the body of the boom 114. The crane head may be used to radially move the interface end of the charging cable 116, for example.

The battery charger 110 is configured to facilitate charging of one or more batteries, such as batteries located within electric vehicles, through a single interface. For example, the battery charger 110 may be configured to charge an electric vehicle battery located in an electric vehicle positioned adjacent the charger and electrically connected to battery charger 110 via charging cable 116 and connector 115, or multiple electric vehicle batteries positioned adjacent the charging station 100 and individually and successively connected to battery charger 110 via charging cable 116 and connector 115, such as batteries in multiple electric vehicles, or multiple batteries located in or on a single vehicle and individually and successively connected to battery charger 110 via charging cable 116 and connector 115, such as a vehicle transport truck. The battery charger 110 may be configured to convert AC power to DC power. This conversion may be used to accommodate a power grid configured to provide AC power to a plurality of electric vehicle batteries that are designed to be charged by DC power. The battery charger 110 can include a transformer 430 to facilitate conversion from AC to DC. The transformer may be configured to adjust voltage levels in accordance with a parameter of a battery being charged by the charging station 100. For example, the battery charger 110 may be configured to charge with a relatively high voltage for a battery configured for fast charging and a relatively low voltage for a battery not configured for fast charging.

The battery charger 110 may be configured to signal when the charging process is complete. This signal may be provided in various forms. A visual signal, such as a light turning on or changing color, may be employed to indicate completion. Alternatively, an audible signal, such as a beep or a series of beeps, may be sounded to notify the user. In addition to these on-site signals, the battery charger 110 may be equipped to send a notification to a remote server, enabling delivery of signals to devices like smartphones and other computing devices, which allows a user of the charging station 100 the ability to monitor a charging process remotely.

The battery charger 110 can be configured to provide electric power to operate the support member 112. The battery charger 110 may be configured to provide a first electrical signal, such as an AC signal, to power movement of the support member 112 as described above. The battery charger 110 may be configured to operate a plurality of support members 112.

In addition to the AC signal that powers the support member 112, the charger 410 may be configured to provide a second electrical signal, such as a DC signal, for charging of a battery, such as a battery in or otherwise associated with an electric vehicle. This dual-signal capability allows the charger 110 to actuate the support member 112 while also delivering the necessary DC power to charge a battery of an electric vehicle.

The battery charger 110 may include a fault detection system. One function of the fault detection system is to monitor the thermal integrity of the battery charger 110. For example, the fault detection system may be configured to employ a fire suppression protocol if a fire is detected within the charging station 100. To detect said fire, the charger 410 may include a plurality of thermal cameras or one or more suitable sensors, such as temperature sensors.

In some embodiments, a charging station includes more than one support member, such as first and second support members, a plurality of support members, three support members, or more than three support members. In these embodiments, an appropriate number of booms and charging cables are also included, such as one boom and one charging cable for each support member.

Also in these embodiments, the battery charger can be configured to power multiple support members, allowing for simultaneous charging of multiple vehicles or addressing vehicles with charging ports in different positions. The battery charger may provide an AC signal to power the support members and a DC signal for vehicle charging.

In some embodiments, a charging station includes multiple booms attached to a single support member, such as first and second booms, a plurality of booms, three booms, or more than three booms. In these embodiments, an appropriate number of charging cables is included, such as one charging cable associated with each boom.

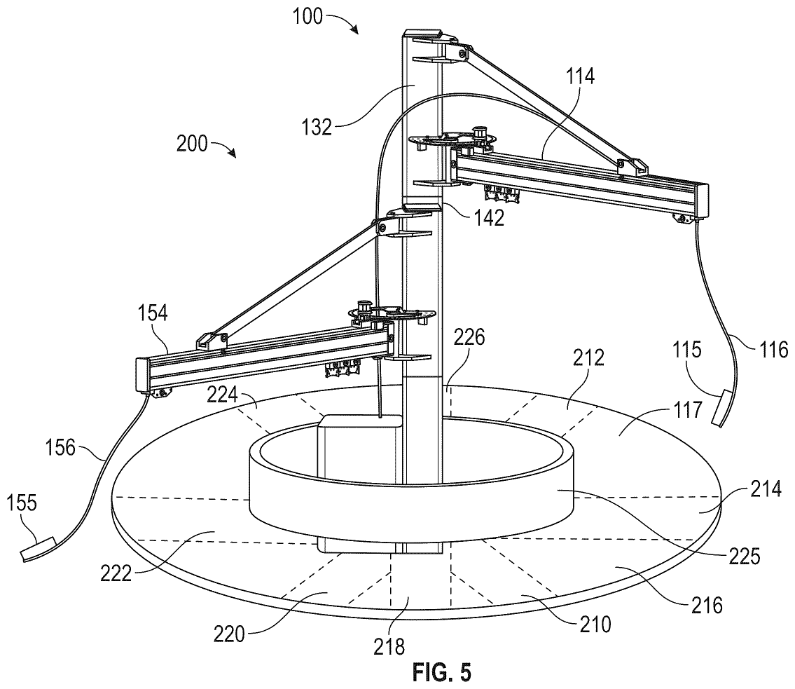

For example, as illustrated in FIG. 5, charging station 100 includes first 132 and second 142 support members disposed over support beam (not visible in FIG. 5). The first support member 132 is axially spaced from the second support member 142 along the axis of the support beam and each of the first 132 and second 142 support members is independently rotatable about the axis of support beam. First boom 114 is connected to first support member 132 and second boom 154 is connected to the second support member 142. First charging cable 116, with handle 115, is secured to first boom 114 and operatively connected to battery charger 110. Similarly, second charging cable 156, with handle 155, is secured to second boom 154 and operatively connected to battery charger 110. In this example, second charging cable 156 extends through an interior space of boom 154 and second support member 142 to a connection on battery 110, which is not visible in FIG. 5.

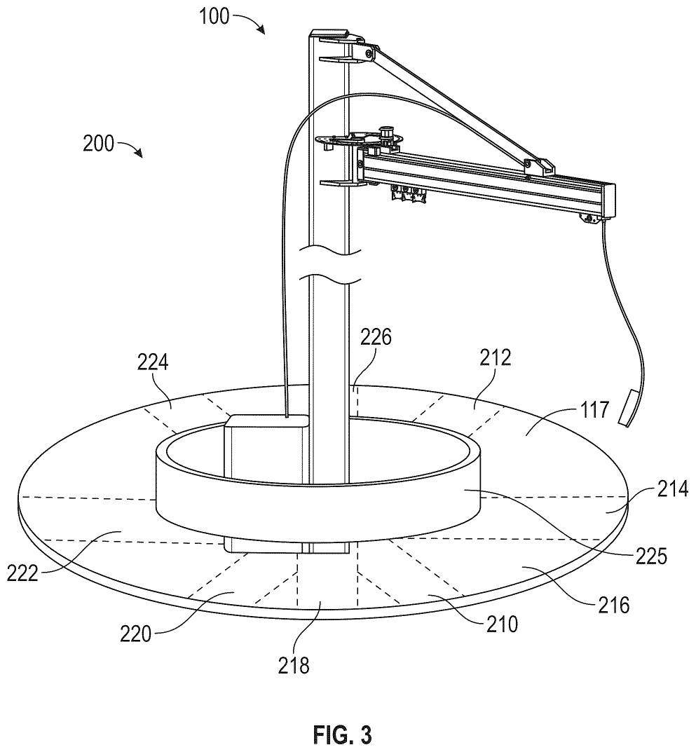

FIG. 3 illustrates an example charging pod 200, which includes a charging station according to an embodiment positioned on a surface 210 with a plurality of charging slots 212, 214, 216, 218, 220, 222, 224, 226 demarcated on the surface 210. In the illustrated example, charging station 100 illustrated in FIG. 1 and described above is included in the charging pod 200. Thus, charging station 100 includes a battery charger 110, a support member 112, a boom 114 attached to and extending radially outward from the support member 112, and a charging cable 116 that is operatively connected to the battery charger and that includes a connector 115 adapted to be electrically connected to an electric vehicle to charge the battery of the electric vehicle via battery charger 110. Support member 112 extends from base 117, which can be a section of ground, support material disposed on the ground, such as concrete, or another suitable material.

Surface 210 can comprise the base 112 of the charging station, such as base 117 of charging station illustrated in FIG. 1 and described above. Surrounding the charging pod 200, ground support features such as traffic cones, lane markings, and pedestrian barriers may be deployed. In an alternate embodiment, the charging pod may also be configured with ground induction charging capabilities, allowing for wireless charging. This induction system is embedded in the floor of the pod and initiates charging when the vehicle is correctly positioned over it. Alongside the charging pods, ground support elements such as dynamic LED lane markers may be employed. These lane markers can change color or pattern to indicate the status of the pod. For example, the LED lane markers may signal red for occupied, green for available, and blue for undergoing maintenance. For added user convenience, the charging pod may include a user interface panel located near the entrance. This panel could display relevant information like charging status and estimated time for charging completion. Users may interact with this panel to customize their charging settings or to access other station services. Additionally, the charging pod may be configured with emergency safety features such as fire suppression systems.

In this example, charging pod 200 includes a barrier 225 extending around support member 112. Barrier 225 prevents a vehicle entering one of the plurality of charging slots 212, 214, 216, 218, 220, 222, 224, 226 from contacting support member 112. In this illustrated embodiment, barrier 225 comprises a ring of material, such as metal, that is attached to the support member 112 and that is elevated above surface 210. Alternatively, barrier 225 can be positioned on surface 210 and not be connected to support member 112. Also, while a ring structure is illustrated for barrier 225, other structures can be used for a barrier in a charging pod according to an embodiment, such as a curved member, multiple curved members, a linear member, multiple linear members, and other suitable structures. The use of a ring structure is considered advantageous, though, at least because it provides the same barrier structure and function to each charging slot of the plurality of charging slots 212, 214, 216, 218, 220, 222, 224, 226.

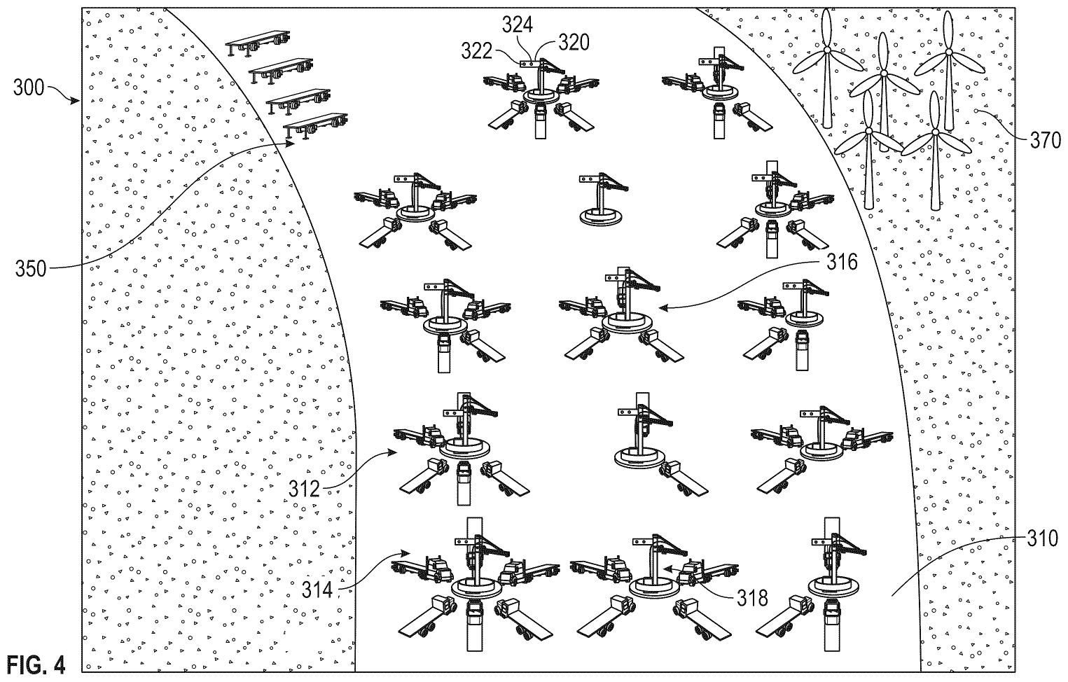

FIG. 4 illustrates an example charging facility 300, which includes a plurality of charging pods 312, 314, 316, 318 positioned on a surface 310. Each of the charging pods 312, 314, 316, 318 includes a charging station according to an embodiment. In the illustrated example charging facility 300, each charging pod 312, 314, 316, 318 comprises a charging pod according to the embodiment described above and illustrated in FIG. 3. In the illustrated example, each charging station in each charging pod includes multiple battery chargers and multiple support members, each rotatable about an axis. Furthermore, each charging station includes a sign 320 to identify the charging station and/or charging pod, the status of the charging station and/or charging pod. For example, each sign 320 can include a first light 322 that, when illuminated, signifies that one or more charging slots surrounding the charging pod is empty and a second light 324 that, when illuminated, signifies that all charging slots surrounding the charging pod are occupied by electric vehicles or are otherwise inaccessible. The charging pods 312, 314, 316, 318 may be arranged in various configurations to optimize the use of space and facilitate easy access for vehicles. In addition to the charging pods, the charging facility may include one or more optional spaces 350 designated for vehicle components, such as disconnected semi-truck trailers. These spaces may be configured to temporarily house the disconnected components while the battery-containing unit of an electric vehicle, such as the tractor units of semi-trucks, are being charged at the charging stations. This feature may be particularly useful for fleet operations, where trucks can drop off a trailer for storage and pick up another trailer that is already loaded, in an effort to streamline a battery charging workflow. The charging facility may also be equipped with a centralized control system, which oversees the operation of each charging station pod and charging station within the facility. This central control system may be configured to allocate resources dynamically, such as directing a vehicle to a specific charging station that matches its charging capabilities or needs, for example, by updating signs 320 on charging pods with current status information. The system may also monitor and manage the charging status of each vehicle, coordinating the plurality of support members, plurality of booms, and battery chargers to maximize efficiency and minimize downtime.

In some embodiments, the charging facility 300 may incorporate a dynamic rerouting algorithm within the centralized control system. This algorithm may be configured to automatically redirect vehicles to alternate charging stations within the facility in real-time, based on various factors such as queue length, charge rate compatibility, or maintenance schedules. The charging facility may also feature advanced safety mechanisms, such as spatial sensors or proximity alarms, to ensure that disconnected components in the optional spaces do not interfere with the operations of the active charging stations. These safety features could be integrated into the centralized control system for seamless operation. In certain embodiments, the charging facility may include a weather-proof enclosure or a covering that can protect the charging stations and disconnected vehicle components from environmental conditions such as rain, snow, or high winds. The enclosure may be modular, allowing for easy expansion of the facility as needs evolve.

Moreover, the charging facility may include renewable energy sources, like solar panels or wind turbines 370, to generate electricity for the charging operations. These renewable sources may be connected to a local energy storage system, allowing the facility to operate even in situations where there is a grid failure.

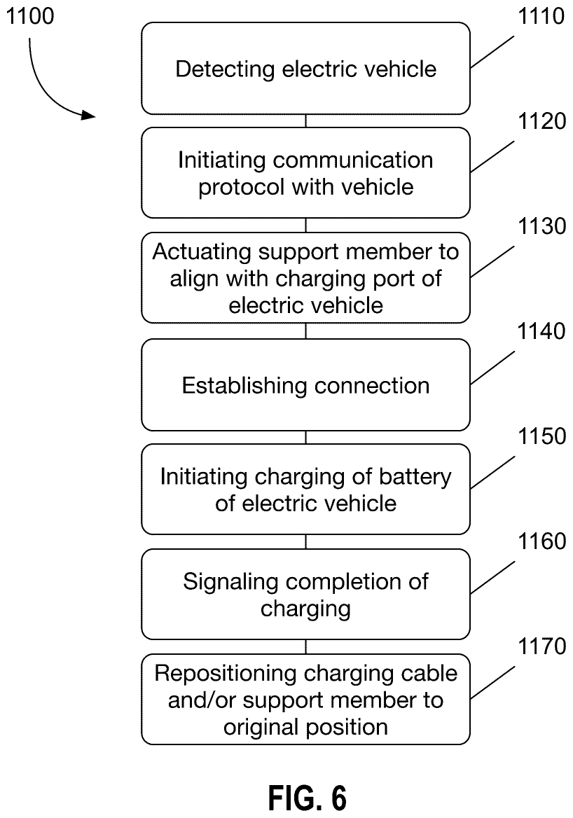

FIG. 6 illustrates a flowchart depicting an example method 1100 method of charging a battery of an electric vehicle. The method may begin with step 1110 of detecting an electric vehicle entering a charging pod. This detection may be performed by proximity sensors located within the charging pod, or alternatively, by a camera system integrated into the charging station. Once the vehicle is detected, step 1120 of initiating a communication protocol with the vehicle detected in step 1110 can be performed. This protocol may include a series of handshakes or identification steps to ensure that the vehicle is compatible with the charging station's capabilities. This step may used for tailoring the charging process according to the vehicle's battery specifications and charging requirements. Following successful communication, step 1130 of actuating support member to align with a charging port of the electric vehicle can be performed. The support member movements may be informed by the information received during the communication protocol, ensuring that the support member aligns correctly with the vehicle's charging port. The support member may move horizontally, vertically, or rotate to accomplish this alignment, all of which can be accomplished through automatic or manual action. Another step 1140 comprises establishing an electric connection between the cable of the battery charger and the electric vehicle, such as by forming a connection between the handle or connector of the charging cable and the port of the electric vehicle. The boom may be configured to move vertically, or even pivot, to ensure a secure connection.

Upon establishment of connection in step 1140, step 1150 of initiating charging of the electric vehicle can be performed. The charger may convert AC power to DC power suitable for the vehicle's battery. During the charging process, the charger may be configured to monitor various parameters, such as voltage levels and charging speed, to optimize the charging operation. The charging station may employ a fault detection system to continuously monitor the integrity of the charging process. Any anomalies detected may trigger corrective actions, ranging from adjusting the charging parameters to halting the charging operation for safety reasons including thermal issues.

Once the vehicle battery reaches a pre-defined charge level or the charging time elapses, the charger may signal the completion of the charging process in step 1160. This signal may manifest as visual cues, audible alarms, or remote notifications to devices like cell phones. Upon completion, the boom may retract the cable, and the support member may return to its original position, making the charging pod available for the next vehicle in step 1170.

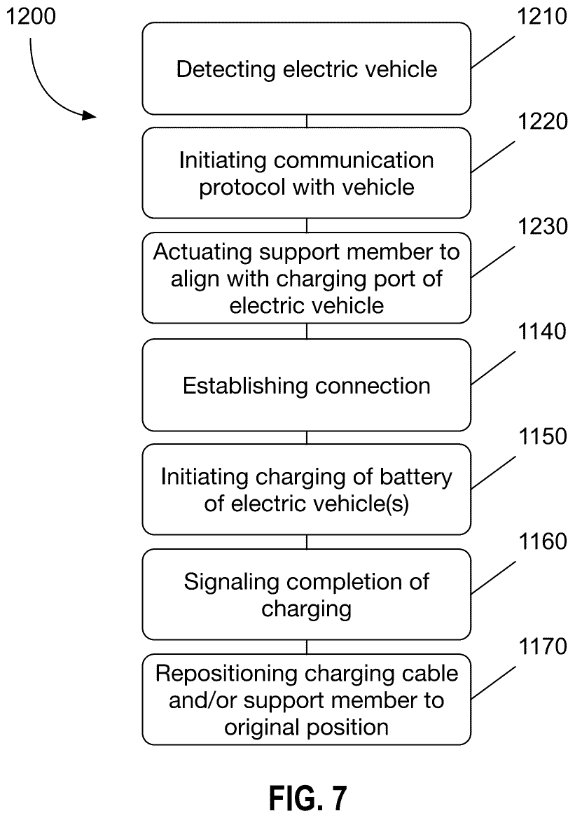

FIG. 7 illustrates a flowchart depicting an example method 1200 of charging batteries of multiple electric vehicles simultaneously at the charging station. The method may begin with step 1110 of detecting an electric vehicle entering a charging pod. This detection may be executed by a plurality of proximity sensors or camera systems integrated into each charging pod. Also, individual vehicles can be detected simultaneously or successively. Once each vehicle is detected, step 1120 of initiating a communication protocol with the vehicle detected in step 1210 can be performed.

Following successful communication, step 1230 of actuating a support member to align with a charging port of the electric vehicle can be performed for each vehicle detected in step 1210. The support member movements may be informed by the information received during the communication protocol, ensuring that the support member aligns correctly with the vehicle's charging port. The support member may move horizontally, vertically, or rotate to accomplish this alignment, all of which can be accomplished through automatic or manual action. Another step 1240 comprises establishing an electric connection between the cable of the battery charger associated with the specific support member and the individual electric vehicle, such as by forming a connection between the handle or connector of the charging cable and the port of the electric vehicle. The boom may be configured to move vertically, or even pivot, to ensure a secure connection.

Once each connection is established, the vehicle charger may commence the charging operations for individual, or all, vehicles in step 1250. The charger may be configured to convert AC power to DC power, adjusting voltage levels according to each vehicle's specific requirements. During this multi-vehicle charging process, the charger may continuously monitor various parameters, such as voltage levels, current, and charging speed, through a centralized control system.

The charging station may employ a fault detection system to continuously monitor the integrity of the multi-vehicle charging process. Any anomalies detected, such as overheating or voltage spikes, may trigger fault measures. These actions could range from adjusting the charging parameters to halting the charging operation entirely for thermal reasons.

Upon reaching pre-defined charge levels or the elapse of set charging time intervals for each vehicle, the charger may signal the completion of the charging processes in step 1260. Embodiments of these signals include visual cues, audible alarms, or remote notifications sent to devices like cell phones or computers. Following the completion signals, the booms may retract their respective cables, and the support members may return to their original or standby positions in step 1270.

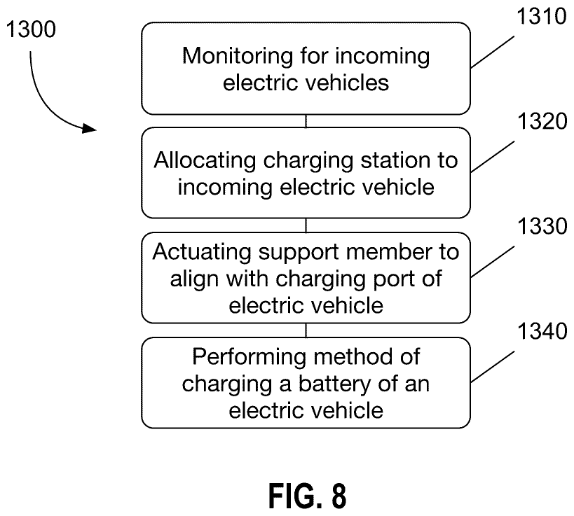

FIG. 8 illustrates a flowchart depicting an example method 1300 for operating a charging facility, encompassing a plurality of charging pods and charging stations according to embodiments. The method begins with the control system monitoring for incoming vehicles in step 1310. This monitoring may be facilitated by a combination of proximity sensors, camera systems, etc. When a vehicle is detected entering the facility, the control system allocates a suitable charging station to the incoming vehicle in step 1320. This allocation may be based on various parameters, such as charging rate compatibility, queue length, and operational status of the charging stations. The control system may employ a dynamic rerouting algorithm to optimize this allocation process. Once a charging station is allocated for the detected electric vehicle, step 1330 of directing the vehicle to the allocated charging station can be performed. This step may include updating signage, such as sign 320 with lights 322, 324 in FIG. 4, on charging pods to reflect current status information to direct a driver of the incoming vehicle, or the incoming vehicle itself, to the allocated charging station. Once the vehicle is directed to a designated charging station, step 1340 of performing a method of charging a battery of an electric vehicle, such as method 1100, can be initiated to charge the battery of the electric vehicle. The control system continuously monitors this process, utilizing feedback from sensors to ensure a secure and efficient charging connection. Concurrently, the control system may manage additional operations within the facility, such as the temporary housing of disconnected components in optional spaces. The control system could dynamically allocate these spaces based on real-time demand and availability.

The particular examples disclosed herein have been selected by the inventors simply to describe and illustrate examples of the invention and are not intended to limit the scope of the invention or its protection, which is to be given the full breadth of the appended claims and any and all equivalents thereof. Artisans of ordinary skill will appreciate that various modifications and alternatives for the described and illustrated examples can be developed in light of the overall teachings of the disclosure. These modifications and alternatives are within the scope of the invention. For example, an element or elements of one example charging station, charging pod, or charging facility described and illustrated herein can be combined with an element or elements of another example charging station, charging pod, or charging facility without departing from the scope of the invention. Similarly, a step or steps of one example method described and illustrated can be combined with a step or steps of another example without departing from the scope of the invention. Furthermore, where no order of steps is necessary for the described methods, the steps can be performed in an order other than the order described for a selected example without departing from the scope of the invention.

I claim:

1. A charging station for an electric vehicle, comprising:
a battery charger;
a support member disposed over a support beam having an axis;
a boom attached to and extending radially outward from the support member; and
a charging cable operatively connected to the battery charger and including a connector adapted to be electrically connected to an electric vehicle to charge the battery of the electric vehicle via battery charger;
wherein the boom is configured to be rotated about the axis of the support beam.

2. The charging station of claim 1, wherein the boom is configured to move vertically during rotation about the axis of the support beam.

3. The charging station of claim 2, wherein the support member is configured to be rotated about the axis of the support beam.

4. The charging station of claim 1, further comprising a second boom attached to the support member.

5. The charging station of claim 4, further comprising a second charging cable operatively connected to the battery charger and including a second connector adapted to be electrically connected to an electric vehicle to charge the battery of the electric vehicle via battery charger.

6. The charging station of claim 1, further comprising a second support member.

7. The charging station of claim 6, wherein the second support member is axially spaced from the first support member along the axis of the support beam.

8. The charging station of claim 7, further comprising a second boom connected to the second support member.

9. The charging station of claim 8, further comprising a second charging cable operatively connected to the battery charger and including a second connector adapted to be electrically connected to an electric vehicle to charge the battery of the electric vehicle via battery charger.

10. The charging station of claim 9, further comprising a barrier extending around the first support member.

11. The charging station of claim 10, wherein the barrier comprises a ring of material.

12. The charging station of claim 11, wherein the material comprises metal.

13. A charging pod for charging multiple electric vehicles, comprising:
a base on which multiple electric vehicles can be positioned;
a battery charger;
a support beam extending from the base and having an axis;
a support member disposed over the support beam;
a boom attached to and extending radially outward from the axis; and
a charging cable operatively connected to the battery charger and including a connector adapted to be electrically connected to an electric vehicle to charge the battery of the electric vehicle via battery charger;
wherein the boom is configured to be rotated about the axis of the support beam.

14. The charging station of claim 13, further comprising a second boom extending radially outward from the axis; and
a second charging cable attached to the second boom and operatively connected to the battery charger, the second charging cable including a second connector adapted to be electrically connected to an electric vehicle to charge the battery of the electric vehicle via battery charger.

15. The charging station of claim 14, further comprising a second support member.

16. The charging station of claim 15, wherein the second support member is axially spaced from the first support member along the axis of the support beam; and
wherein the second boom is attached to the second support member.

17. The charging station of claim 16, further comprising a barrier extending around the first support member.

18. The charging station of claim 17, wherein the barrier comprises a ring of material.

19. The charging station of claim 11, wherein the material comprises metal.

20. A charging pod for charging multiple electric vehicles, comprising:
a base on which multiple electric vehicles can be positioned;
a battery charger;
a support beam extending from the base and having an axis;
a first support member disposed over the support beam;
a second support member disposed over the support beam and axially spaced from the first support member along the axis;
a first boom attached to and extending radially outward from the first support member, the first boom configured to be rotated about the axis;
a second boom attached to and extending radially outward from the second support member, the second boom configured to be rotated about the axis;
a first charging cable attached to the first boom and operatively connected to the battery charger, the first charging cable including a first connector adapted to be electrically connected to an electric vehicle to charge the battery of the electric vehicle via battery charger;
a second charging cable attached to the second boom and operatively connected to the battery charger, the second charging cable including a second connector adapted to be electrically connected to an electric vehicle to charge the battery of the electric vehicle via battery charger; and
a barrier extending around the first support member and disposed above the base.
